(19) United States
(12) Patent Application Publication
(10) Pub. No.: US 2010/0187727 A1
(43) Pub. Date: Jul. 29, 2010

(54) METHOD OF VOID FREE FOR MOLDING PRODUCT

(76) Inventors: Gi Jong Yu, Incheon-city (KR); Gu Seob Kwon, Chungcheongbuk-Do (KR)

Correspondence Address: GREER, BURNS & CRAIN, 300 S WACKER DR, 25TH FLOOR, CHICAGO, IL, 60606, US

(21) Appl. No.: 12/302,444

(22) PCT Filed: May 8, 2007
(86) PCT No.: PCT/KR2007/002246

§ 371 Date: Mar. 23, 2010

(30) Foreign Application Priority Data
May 25, 2006 (KR) 10-2006-0047100

(51) Int. Cl. B29C 45/73

(52) U.S. Cl. 264/327

(57) ABSTRACT

A method of removing voids from a molded product is disclosed, in which a main mold, is connected with an auxiliary mold, and molten material in the auxiliary mold moves toward the main mold by adjusting a cooling time between the main mold and the auxiliary mold, thereby preventing voids from occurring in the molded product having a large thickness, preventing sink marks from occurring. The method includes the steps of: preparing a main mold and an auxiliary mold connected with the main mold; introducing molten resin into the auxiliary mold and the main mold; and retarding cooling of the auxiliary mold such that negative pressure in the auxiliary mold is different from that in the main mold due to a cooling time difference and a temperature difference. The molten resin in the auxiliary mold moves toward the main mold, and then is filled in the main mold during cooling.

### TECHNICAL FIELD

The present invention relates to a method of removing voids from a molded product, and more particularly, to a method of removing voids from a molded product, in which a main mold, in which a product is molded, is connected with an auxiliary mold, and molten material in the auxiliary mold moves toward the main mold by adjusting a cooling time between the main mold and the auxiliary mold, thereby preventing voids from occurring in the middle portion of the molded product having a large thickness or various thicknesses, preventing sink marks from occurring at the molded product having a small thickness, and enhancing mechanical rigidity and reliability of the molded product.

### BACKGROUND ART

In general, when a product that is thick or has non-uniform thickness distribution is molded, the molded product has voids. In this case, the voids of the thick product occur at the half-thickness position thereof, and the voids of the product having non-uniform thickness distribution occur at the thickest position thereof, i.e. at a position that is cooled at the slowest rate.

The voids occur on various reasons. When heat is applied to the material for molding (hereinafter, referred to as “resin”), the resin swells, i.e. is increased in specific volume. When cooled, the resin is cooled from the outside toward the inside thereof. As such, the resin always has internal temperature higher than external temperature. Thus, although the surface of the resin is cooled and solidified, the inside of the resin maintains fluidity without solidification. In this state, the pressure applied during the molding does not compensate for volume shrinkage occurring at the inside of the resin, due to the reduction of the specific volume. Thus, the relative pressure is gradually reduced, and thereby the negative pressure is gradually increased. Ultimately, the inside of the resin results in lack of the resin to be filled. In this case, the resin moves to a portion where the viscosity thereof is strongest, the portion is subjected to cavitation.

Particularly, this cavitation phenomenon occurs at a thick molded product, but not at a thin molded product. This is because injecting pressure and holding pressure makes up for the cavitation in the case of the thin molded product. In the case of the thick molded product, the cavitation causes the sink marks (skin collapse phenomenon). However, in the case of the thick molded product that is so thick that the negative pressure generated at the inside thereof does not cause the shrinkage into the sink marks, the cavitation causes the voids.

In order to solve this problem, recently, two of the known injection molding methods, i.e. the first method of continuously stacking thin products and the second method of mixing a foaming agent and a foaming retardant with resin and molding the mixture, have broadly been used.

However, in the case of the molded product that is molded in the first method, no void occurs, but a stacked interface exists inside or outside the product, and thus separation occurs at the stacked interface. Further, because the injection molding is continuously performed up to the final thickness of the molded product, the molded product increases injection cost.

Further, in the case of the molded product that is molded in the second method, micro voids that are not easily observed with a naked eye are dispersed, and thus the molded product has poor mechanical properties. Further, when the reaction of the foaming retardant is improper, a failure rate of the molded product is increased.

### DISCLOSURE OF INVENTION

### Technical Problem

Accordingly, the present invention has been made in an effort to solve the problems occurring in the related art, and an object of the present invention is to provide a method of removing voids from a molded product, in which a main mold, in which a product is molded, is connected with an auxiliary mold, and molten material in the auxiliary mold moves toward the main mold by adjusting a cooling time between the main mold and the auxiliary mold, thereby preventing voids from occurring in the middle portion of a thick zone of the molded product having a large thickness or various thicknesses, preventing sink marks from occurring at the molded product having a small thickness, and enhancing mechanical rigidity and reliability of the molded product.

### Technical Solution

In order to achieve the above object, according to an aspect of the present invention, there is provided a method of removing voids from a molded product. The method includes the steps of: preparing a main mold by which a product to be molded is molded and an auxiliary mold connected with the main mold; introducing molten resin into the auxiliary mold and the main mold; and retarding cooling of the auxiliary mold such that negative pressure in the auxiliary mold is different from that in the main mold due to a cooling time difference and a temperature difference. The molten resin in the auxiliary mold moves toward the main mold, and then is filled in the main mold in which the voids occur during the cooling.

Here, the auxiliary mold may have a volume greater than a specific volume that corresponds to a volumetric difference between a molten state and a solidified state of the molten resin of the main mold.

Preferably, the main mold may be forcibly cooled using ordinary cooling water, whereas the auxiliary mold is naturally cooled. Further, the main mold may be naturally cooled, whereas the auxiliary mold may be heated using an ordinary heat supply device. In addition, the main mold may be forcibly cooled using ordinary cooling water, whereas the auxiliary mold may be heated using an ordinary heater.

Further, in the case in which the main mold is cooled while the cooling of the auxiliary mold is retarded, the auxiliary mold may be cooled under the same conditions as the main mold when the molten resin in the main mold is solidified, and the molded product corresponding to an end of the auxiliary mold may be bored so that the molten resin in the auxiliary mold moves toward and is filled in the main mold in which the voids occur due to the atmospheric pressure.

In addition, when the cooling of the main and auxiliary molds is completed, the main and auxiliary molds may be separated from each other, and then the molded product formed by the auxiliary mold may be machined in a desired shape.

### ADVANTAGEOUS EFFECTS

As described above, according to the present invention, a main mold, in which a product is molded, is connected with an auxiliary mold, and molten material in the auxiliary mold moves toward the main mold by adjusting a cooling time between the main mold and the auxiliary mold, thereby preventing voids from occurring in the middle portion of the molded product having a large thickness or various thicknesses, preventing sink marks from occurring at the molded product having a small thickness, and enhancing mechanical rigidity and reliability of the molded product.

### BEST MODE FOR CARRYING OUT THE INVENTION

Hereinafter, a method of removing voids from a molded product in accordance with an exemplary embodiment of the present invention will be described.

In order to mold a product with no void, first, a main mold by which a product to be molded is molded and an auxiliary mold connected with the main mold are prepared. The auxiliary mold is disposed on one side of the main mold. Particularly, in the case of a product, such as a ball for a typical ball valve, having a through-hole at the center thereof, the auxiliary mold is disposed in the main mold such that molding resin can be introduced from the inside to the outside of the main mold. Preferably, the auxiliary mold is adapted to have a volume greater than that of the molding resin, which shrinks from reduction of a specific volume caused by cooling of the main mold, at all times.

When the main and auxiliary molds are prepared, molten resin is introduced into any one of the main and auxiliary molds as in an ordinary injection molding method. Preferably, the molten resin is effectively introduced into the auxiliary mold. In this manner, the molten resin introduced into the auxiliary mold is filled in the main and auxiliary molds.

As described above, when the molten resin is completely filled in the main and auxiliary molds, the main and auxiliary molds are cooled. The main mold is cooled while the cooling of the auxiliary mold is retarded. At this time, the molten resin in the cooled main mold is solidified from the outside thereof. The solidification is retarded at the inner center of the molten resin. When cooled, the filled resin is reduced in volume by a volume (or a specific volume) increased when heated. The filled resin results in shortage in the state (gel state) in which the filled resin is hard at the outside thereof and is soft at the inside thereof. Thus, the center of the filled resin at which the solidification is latest suffers negative pressure. This negative pressure is generated on the following reason. The molten resin is injected into the mold at a predetermined pressure, and thus the mold is under positive pressure to some degree. In this state, the molten resin is cooled from the outside thereof, and then the outside of the cooled resin has a layer that is so thick that deformation does not occur due to internal pressure. Regardless of the pressure applied when injected, the molten resin is contracted in proportion to a volume reduced by the cooling, and then is short of the volume in proportion to the volume at which the inside thereof that is not yet solidified is contracted. Thereby, the negative pressure is generated. In other words, when the negative pressure is generated due to the reduction of the specific volume and is increased in the main and auxiliary molds, the negative pressure of the main mold is lower than that of the auxiliary mold by retarding the cooling of the auxiliary mold. For this reason, the molten resin of the auxiliary mold moves toward the main mold, and particularly the inside of the main mold at which the voids occur. Then, the molten resin is filled in the main mold in which the voids occur.

Preferably, the main mold is forcibly cooled using typical cooling water, whereas the auxiliary mold is naturally cooled. Alternatively, the main mold may be naturally cooled, whereas the auxiliary mold may be heated using a typical heat supply device, for example a typical heater. Further, the main mold may be forcibly cooled using typical cooling water, whereas the auxiliary mold may be heated using a typical heater.

Meanwhile, in the case in which the main mold is cooled while the cooling of the auxiliary mold is retarded, the auxiliary mold is cooled under the same conditions as the main mold when the molten resin in the main mold is solidified, and the molded product corresponding to an end of the auxiliary mold is bored. At this time, the molten resin in the auxiliary mold easily moves toward and is filled in the main mold in which the voids occur due to the atmospheric pressure.

In this manner, when the cooling of the main and auxiliary molds is completed, the main and auxiliary molds are separated from each other, and then the molded product produced by the auxiliary mold is machined in a desired shape.

### INDUSTRIAL APPLICABILITY

As can be seen from the foregoing, according to the present invention, the molten resin is introduced into the auxiliary mold connected with the main mold by which the product is molded, and then is caused to move toward the main mold by adjusting the cooling time between the main mold and the auxiliary mold. Thereby, the voids can be prevented from occurring in the middle portion of the molded product having a large thickness or various thicknesses, and the sink marks can be prevented from occurring at the molded product having a small thickness. Further, the post deformation of the molded product can be prevented, and the mechanical rigidity and reliability of the molded product can be enhanced.

Although the invention herein has been described with reference to particular embodiments, it will be apparent to those skilled in the art that various modifications and variations can be made in the invention without departing from the spirit and scope of the present invention as defined by the appended claims.

1. A method of removing voids from a molded product, the method comprising the steps of:
preparing a main mold by which a product to be molded is molded and an auxiliary mold connected with the main mold;
introducing molten resin into the auxiliary mold and the main mold; and
retarding cooling of the auxiliary mold such that negative pressure in the auxiliary mold is different from that in the main mold due to a cooling time difference and a temperature difference,
whereby the molten resin in the auxiliary mold moves toward the main mold, and then is filled in the main mold in which the voids occur during the cooling.

2. The method as set forth in claim 1, wherein the auxiliary mold has a volume greater than a specific volume that corresponds to a volumetric difference between a molten state and a solidified state of the molten resin of the main mold.

3. The method as set forth in claim 1, wherein the main mold is forcibly cooled using ordinary cooling water, and the auxiliary mold is naturally cooled.

4. The method as set forth in claim 1, wherein the main mold is naturally cooled, and the auxiliary mold is heated using an ordinary heat supply device.

5. The method as set forth in claim 1, wherein the main mold is forcibly cooled using ordinary cooling water, and the auxiliary mold is heated using an ordinary heater.

6. The method as set forth in claim 1, wherein, in the case in which the main mold is cooled while the cooling of the auxiliary mold is retarded, the auxiliary mold is cooled under the same conditions as the main mold when the molten resin in the main mold is solidified, and the molded product corresponding to an end of the auxiliary mold is bored so that the molten resin in the auxiliary mold is easily filled into the main mold in which the voids occur due to the atmospheric pressure.

7. The method as set forth in claim 1, wherein, when the cooling of the main and auxiliary molds is completed, the main and auxiliary molds are separated from each other, and then the molded product produced by the auxiliary mold is machined in a desired shape.
